(19) United States
(12) Patent Application Publication
(10) Pub. No.: US 2010/0008541 A1
(43) Pub. Date: Jan. 14, 2010

(54) Method for Presenting Images to Identify Target Objects

(76) Inventor: Clifton L. Forlines, Newton, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/169,315

(22) Filed: Jul. 8, 2008

(51) Int. Cl. G06K 9/00; G06K 9/34

(52) U.S. Cl. 382/103; 382/168; 382/173; 382/132

(57) ABSTRACT

A method presents a set of images to a viewer. The images include objects, which can be either distractor objects or target objects. A prevalence of the target objects is substantially lower than the distractor objects. Each image is segmented into portions so that each portion includes one object. The portions are then combined into a combined image. The combined image is presented to a viewer so that the target objects can be accurately and rapidly identified. The combining of the portions can be random or ordered in either the spatial or temporal domain.

### FIELD OF THE INVENTION

This invention relates generally to presenting images, and more particularly to presenting images so that the images can be searched to identify target objects.

### BACKGROUND OF THE INVENTION

Human operator are frequently required to visually search medical, baggage screening, and satellite images to identify target objects. Because the frequency of the target objects is low with respect to distractor objects in the images, the searching is difficult.

Visual search has been studied extensively, and many underlying theories have been presented as to the nature of the human visual system. However, no single model of the human visual system explains the variety of experimental results that have been reported.

In a typical visual search experiment, participant viewers are asked to search for target objects in a set of images that may or may not contain the target objects, and does contain a larger and varying number of distracter objects. Normally, the target object is present in about 50% of the images. The viewers respond to each image by indicating whether or not they believe the target object is present. Participants are asked to respond as rapidly and as accurately as possible, and the dependent variables measured are reaction time and error rate.

For difficult searches, it is known that search durations are linearly correlated with the number of distracter objects present in the image. Similarly, error rates are typically higher for images that contain a large number of distracter objects. Missing a target object, which increases the false-negative error rate, is much more common than incorrectly identifying target objects, which increases the false-positive error rate.

Problems with Low Target Prevalence

Target object prevalence is the percentage of images in which the target objects appears. In many important tasks, such as baggage screening and medial slide and x-ray analysis, targets of interest, such as weapons, malignant cells and tumors, are very rare. One study used target object prevalence of 50%, 10% and 1%. That study showed that error rate increased significantly as target prevalence decreased from 7% error in the 50% prevalence trials, to 16% error for 10% prevalence, to 30% error for 1% prevalence. This disturbingly seems to indicate that if a target is rare, it is rarely found.

Visual Search Experiments

One experiment tracked eye movement of radiologists searching mammograms for tumors. That study was motivated by the fact that 10-30% of breast cancers are missed by radiologists, and are only found retrospectively. Their results included the interesting finding that missed tumors were often visually inspected by the radiologist, indicating that visual search was not the cause of the problem, but rather that decision making process, or some other perceptual process was.

In regards to modeling human behavior and performance in visual search tasks, another study attempted to produce a unified visual search model for predicting search time in user interfaces. That unified model was based partly on models for eye movement and searching strategies for hierarchical menus used in graphical user interfaces. Results indicated a close match between the model's predicted path and actual eye movements, as recorded by a commercial eye tracking system for hierarchical menu searching. While that model could be useful in the design of graphical user interfaces, it is unclear if the model will help with the more general task of searching for targets in more general images.

Rapid Serial Visual Presentation

The human visual system is extremely adept at rapidly processing visual images. Perceptual psychologists have long known this in the field of Rapid Serial Visual Presentation (RSVP) in terms of its use in human computer interfaces. In general, RSVP techniques trade time for space when presenting a set of images, and differ mainly in their presentation and animation of images.

The most basic RSVP method involves a temporal sequencing of images. This technique is similar to a slide show, channel flipping, and standard video playback. That technique has also been called “keyhole mode,” because each moment in time gives the viewer only a single piece of the dataset, much like looking through a keyhole gives the viewer only a single piece of the scene behind the door at any one time. Keyhole is by far the best understood RSVP technique, because it has been used in many psychology experiments. While well understood in the field of psychology, there has been less research and fewer experiments in the field of human computer interaction.

A number of experiments comparing multiple RSVP techniques for different tasks have been conducted. None of these experiments found any performance benefits by using more sophisticated techniques. Additionally, participants preferred the keyhole technique in a simulated task over other techniques, and performed equally well in an image recognition task when using the keyhole and other techniques.

### SUMMARY OF THE INVENTION

The embodiments of the invention provide a method for presenting images that reduce the negative effects of low target prevalence during a visual search. It is well known that viewers' ability to accurately locate target objects in images is severely affected by the prevalence of the target objects. In general, when targets are rare, they are difficult to find. This negative effect greatly impacts critical real world tasks, such as baggage screening and cell slide pathology, in which target objects are rare.

A method presents a set of images to a viewer. The images include objects, which can be either distractor objects or target objects.

As a characteristic of the images, a prevalence of the target objects is substantially lower than the distractor objects.

Each image is segmented into portions so that each portion includes one object.

The portions are then combined into a combined image. The combined image is presented to a viewer so that the target objects can be accurately and rapidly identified.

The combining of the portions can be random or ordered in either the spatial or temporal domain.

### BRIEF DESCRIPTION OF THE DRAWINGS

FIGS. 1 and 2A are block diagrams of methods for presenting images spatially according to an embodiment of the invention;

FIG. 2B is a block diagram of possible spatial ordering for segmented portions;

FIGS. 3-4 are schematics of possible eye gaze paths according to an embodiment of the invention;

FIG. 5 is a schematic comparing perception and eye movement time for viewing the images presented according to the embodiments of the invention;

FIG. 6 is a block diagram of method for presenting images temporally according to an embodiment of the invention;

FIG. 7 is a block diagram of a method for presenting images segmented with a sliding window according to an embodiment of the invention.

### DETAILED DESCRIPTION OF THE PREFERRED EMBODIMENTS

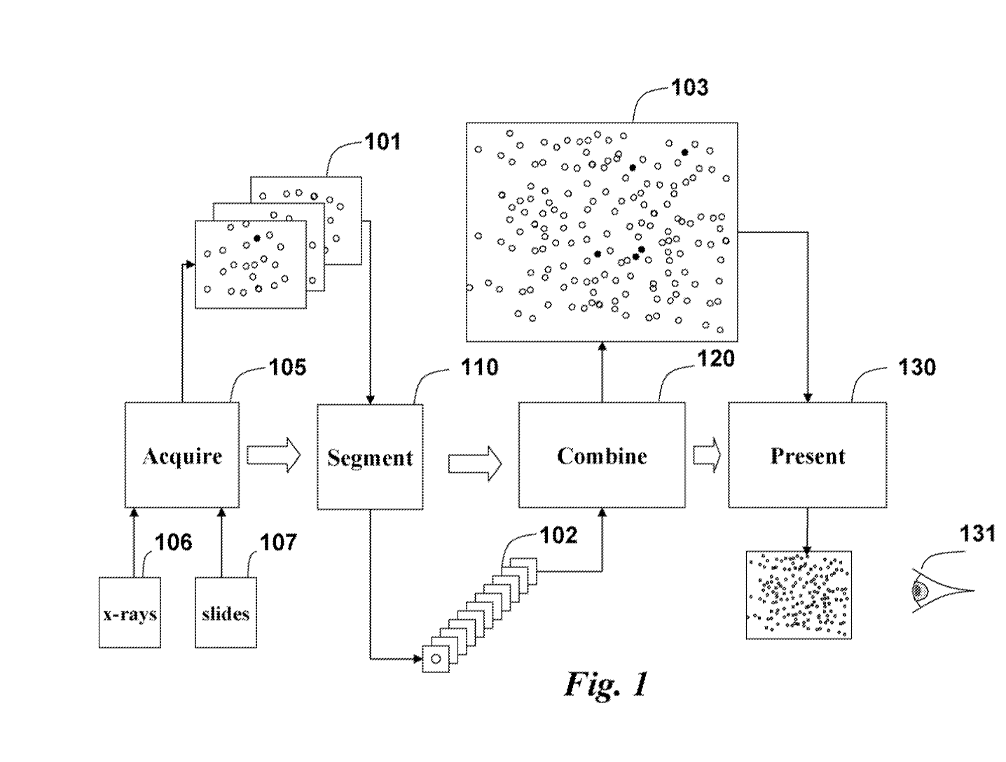

As shown in FIG. 1, the embodiments of our invention provide a method for presenting a set of images 101 to identify target objects. The images include distractor object (while circles) and target objects (black circles). As an important characteristic of the images, the prevalence of the target objects is substantially lower than the distractor objects.

In a preprocessing step, the images can be acquired 105 with x-rays 106, or obtained from pathology slides 107. Other types of images can also be processed. It is known that searching such images rapidly and accurately is extremely difficult.

Each image I in a set of N images 101 is segmented 110 into a set of individual portions 102, such that each portion includes one object. Any segmentation techniques can be used, including k-means clustering, histogram based techniques, edge detection, region growing, and other foreground/background separation techniques. The portions 102 are then combined 120 into a single combined image 103 that is then presented 130 to a viewer 131 to identify the target object rapidly and accurately.

The underlying idea behind our method is as follows. A probability of encountering the target object T in an image I is p(T_{I}). The laws of probability indicates that when N images are combined, e.g., by combining into a single combined image C 103, the probability p(T_{C}) of encountering the target object Tin the combined image C is equal to N times the probability of finding the target T in image I

p(T_{C})=N·p(T_{I}).

If the probability p(T_{I}) is very low, then it interferes with the viewer's ability to accurately search through the images. We raise the probability of identifying the target objects by the combining.

Indeed, any desired target prevalence can theoretically be met by increasing N. This tradeoff does not come without cost. It is well known that the difficulty of visual search increases with the number of distracter objects. Thus, searching through a combined images is significantly more difficult than searching through the unsegmented images 101.

We could skip the segmentation and combining steps, and instead simply tile the set of low prevalence images to form a high-prevalence image. However, there is some evidence that a tiled image leads to higher error rates compared to the sequential viewing of each of the images alone. A possible explanation for this effect is that viewers treat each tile as a separate image, resulting in little perceptual and cognitive differences between the tiled and conventional sequential arrangements.

Therefore, in one embodiment, the segmented portions 102 are arranged randomly in the combined image 103 to remove the appearance of tiled images. The goal is make the viewers treat our combined image as a single image. The size of the combined image can be about five times larger that of the individual images, although this can vary.

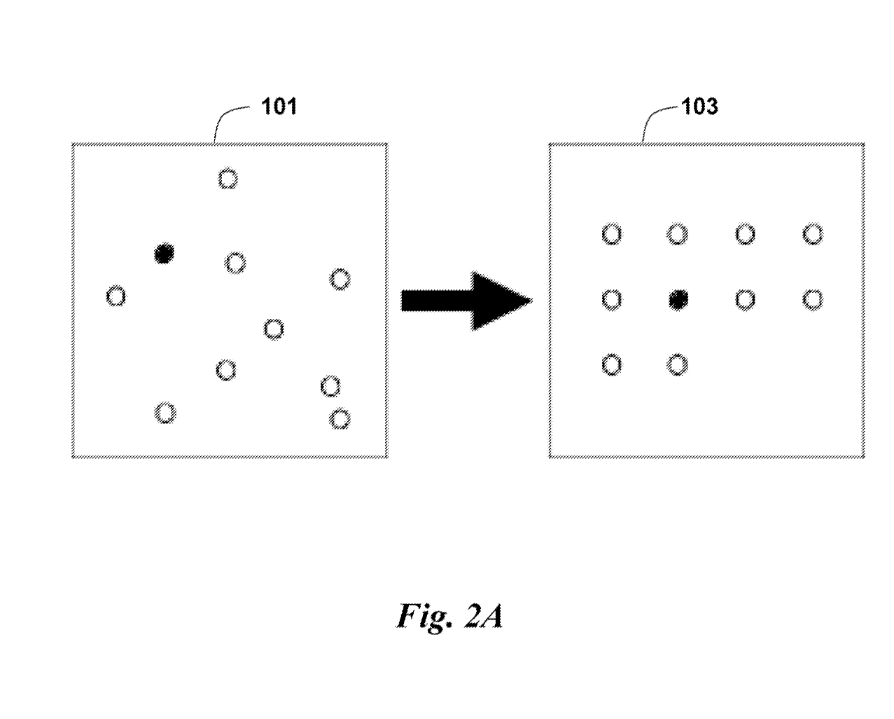

In another embodiment as shown in FIG. 2A, the portions 102 are ordered in the combined image. The motivation for this technique is twofold. First, previous work using eye trackers have shown that the human perceptual system is very inefficient in terms of the path that one's gaze takes when randomly searching an image. By presenting the objects in an orderly arrangement, we encourage the viewer to take a more efficient path that minimizes traversal. Second, viewers often skip objects or visit the same objects on multiple occasions. The orderly layout gives the viewers the confidence that they have inspected every object in the image and enables them to view each object only once. FIG. 2B shows alternative possible spatial orders, such as grid, S and oval. The overall goals are to guide the gaze in a most efficient manner and to ensure that every object in the image is viewed.

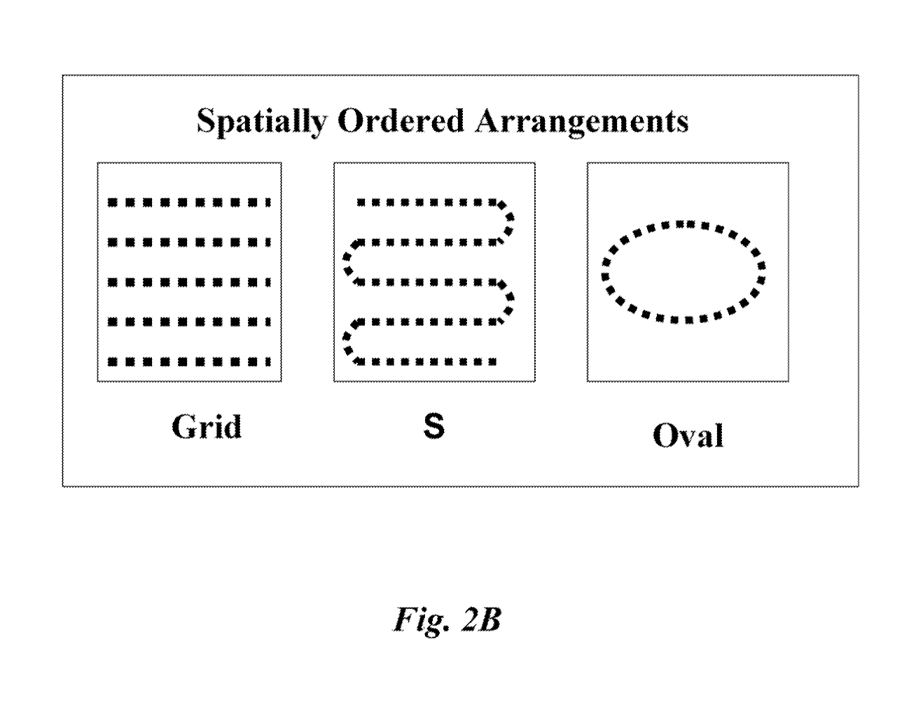

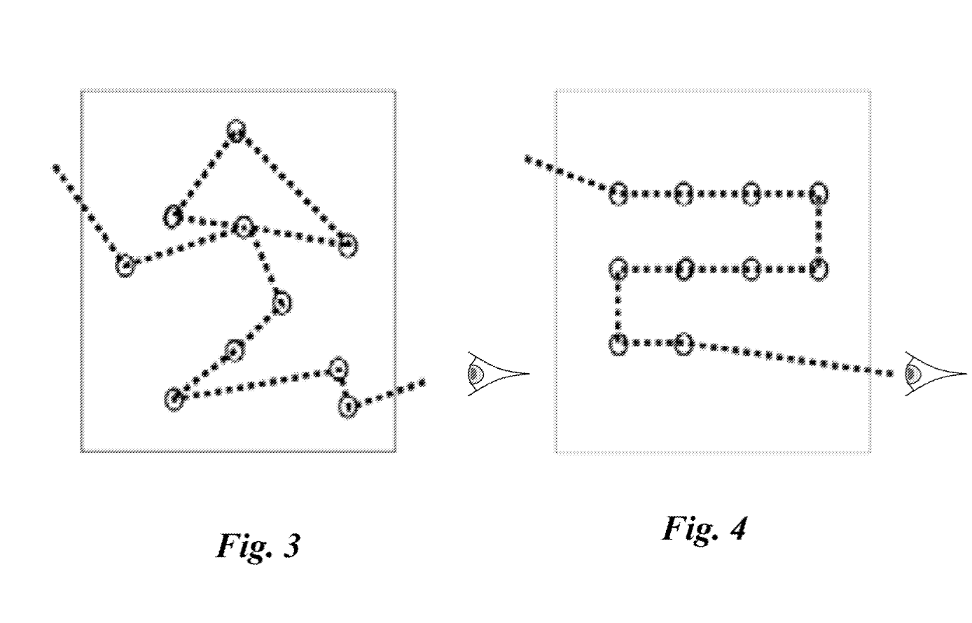

FIGS. 3 and 4 compare possible gaze path through images with the random and ordered arrangement of the portions.

Both of the above techniques therefore use spatial combining of the segmented portions, one being random, and the other being ordered.

We believe that the ordered layout reduces the total traversal distance, as well as remove the reviewing of potential target objects in the image.

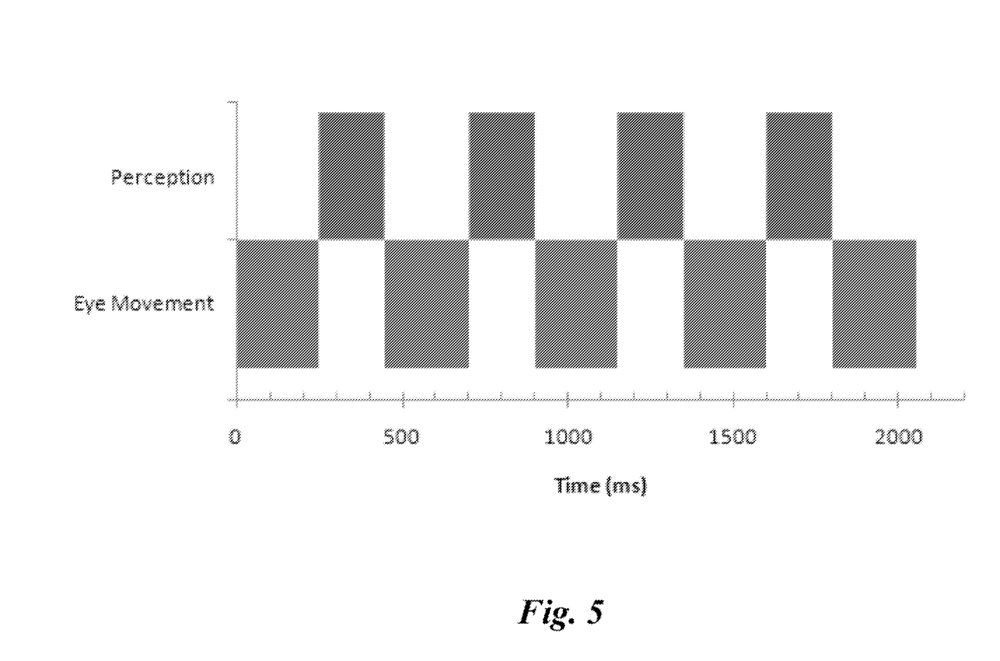

When searching an image, a large fraction of the time is spent moving one's eyes around the image and fixating them oil potential targets. On average, humans can only fixate on a target every 250 ms. Psychology research provides ample evidence that humans are able to rapidly process images. For example, a 200 ms glimpse of an image is sufficient for object recognition and most other real world tasks. Because some types of image processing occur faster than gaze direction, eye movement becomes the limiting factor in many visual searching tasks as shown in FIG. 5.

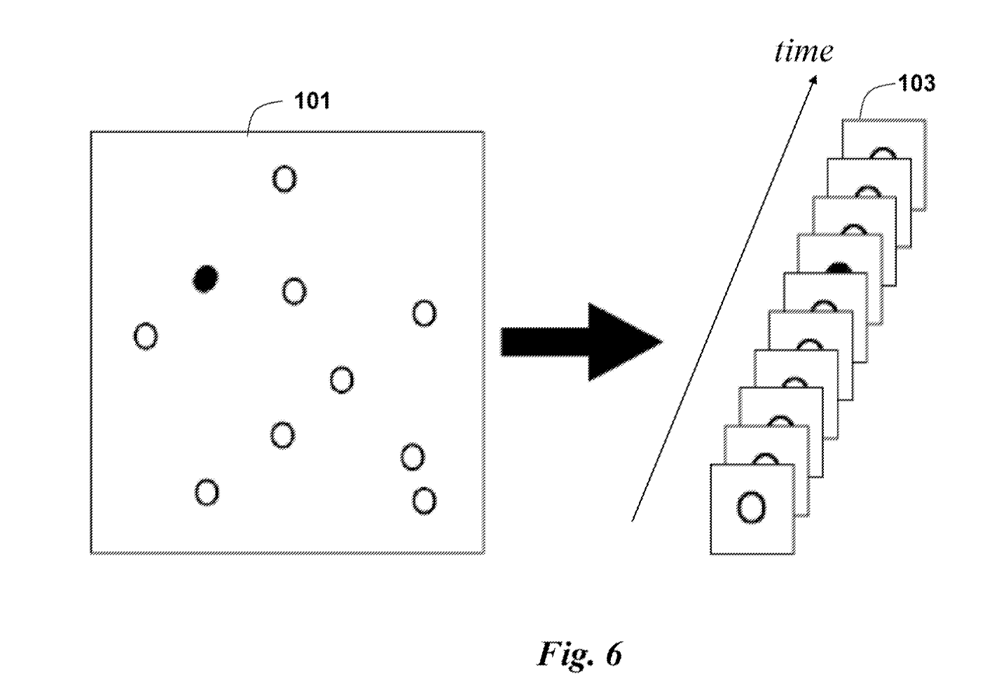

Therefore, in another embodiment, as shown in FIG. 6, we rapidly present at the same location of the display, the small segmented portions 102 of each image, over time. We call this temporal combining. The order of presentation can be random. This way, the viewers do not have to move their eyes as much, and can rapidly process many portions quickly.

The input images 101 are first segmented into portions. Rather than combining the portions spatially, we combine the portions temporally by presenting the portions at the same display location. Individual portions are small enough to be perceived immediately at a glance, and the viewer's eyes can remain focused on the single combined location on the display.

Similar to the arrangements described previously, this RSVP technique ensures that every portion of each image is presented and viewed, and none are skipped because the eye remains focused on the same part of the display.

All three methods of presenting can lead to dramatic improvements in search performance, with experimentally reductions of false-negative error rates of 28%, 30%, and nearly 60%, for random, ordered and sequential combined arrangements.

This provides very strong evidence that the means of presenting the segmented portions of an image can greatly affect the viewer's ability to identify targets within the images, and that the presentations according to the embodiments of the invention are indeed effective.

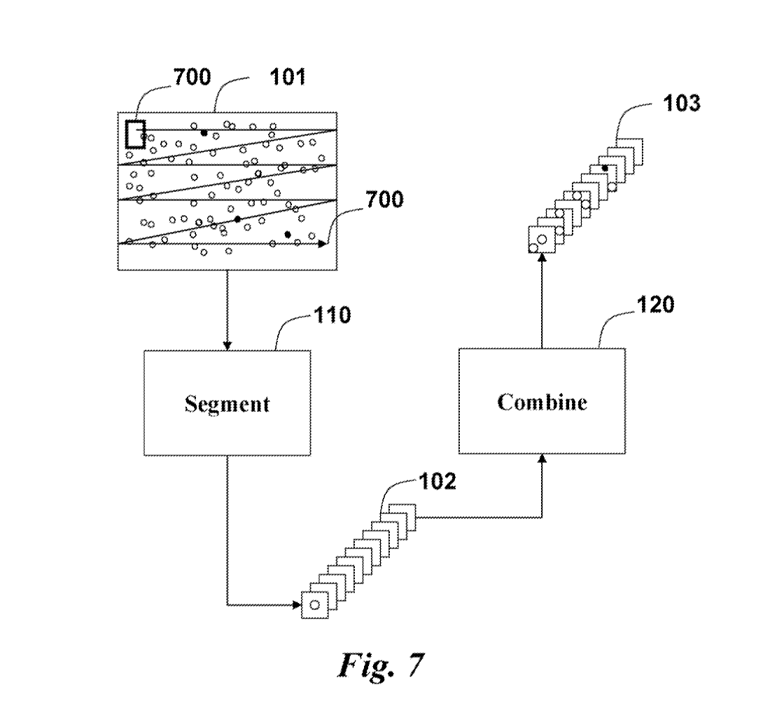

As shown in FIG. 7, our method can also be adapted to images that cannot be easily segmented into portions. Rather than segmenting the image, the segmentation can be performed by sampling portions of the image within a sliding window 700. The size of this window can be about the same or slightly larger than the typical target object, or the window can cover a range of target sizes.

The sliding window is scanned, e.g., in a raster scan order 701, over the image. The result is set of small segmented portions that are amenable to our RSVP presentation. The temporal order of presentation of the portions can be randomized to remove the visual effect of the sliding window being “panned” across the image, which would otherwise seem to animate the portions.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

What claimed is:

1. A method for presenting a set of images to a viewer to identify target objects, comprising the steps of:
segmenting a set of images into portions, in which the set of images includes objects, the objects being either distractor objects or target objects, and a prevalence of the target objects is substantially lower than the distractor objects, and in which each portion includes one object;
combining the portions into a combined image; and
presenting the combined image to a viewer to identify the target objects rapidly and accurately.

2. The method of claim 1, in which the combining composites the portions into a single combined image.

3. The method of claim 2, in which the portions are arranged randomly in the single combined image.

4. The method of claim 2, in which the portions are spatially ordered in the single combined image.

5. The method of claim 1, in which the segmenting uses k-means clustering.

6. The method of claim 1, in which the segmenting uses is histogram based.

7. The method of claim 1, in which the segmenting uses edge detection.

8. The method of claim 1, in which the segmenting uses region growing.

9. The method of claim 1, in which the combining increases a prevalence of the target objects in the combined image.

10. The method of claim 1, in which the portions are combined at a same location of a display and presented sequentially over time.

11. The method of claim 10, in which the positions are presented randomly over time.

12. The method of claim 1, in which the segmenting uses a sliding window to sample the portions of each image within the sliding window.

13. The method of claim 12, in which the portions are combined at a same location of a display and presented sequentially over time.

14. The method of claim 1, further comprising:
acquiring the set of images using x-rays.

15. The method of claim 1, in which the set of images are of pathology slides.
